(19) United States
(12) Patent Application Publication
(10) Pub. No.: US 2004/0010420 A1
(43) Pub. Date: Jan. 15, 2004

(54) System for developing implementing and monitoring a health management program

(76) Inventor: Daniel S Rooks, Marblehead, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/398,389

(22) PCT Filed: Aug. 30, 2001
(86) PCT No.: PCT/US01/41957

(51) Int. Cl. G06F 17/60

(52) U.S. Cl. 705/2

(57) ABSTRACT

The method and system includes an integrated set of technology, scientifically-based algorithms and fitness equipment that: assesses a person's health, fitness and functional status; develops an individualized exercice program to address specific needs and improves limitations in health, fitness and function; monitors exercise program progress and adverse events; continuously adjusts exercise program progression in real time; measures changes in health, fitness and functional status; and reports exercise participation and changes in health, fitness and functional status to the participant, his/her health care provider (e.g., physician, physical therapist, psychologist) and health insurance provider. The method is also a vehicle for knowledge delivery of health education (e.g., nutrition, disease self-management, stress and time management), psychological coping strategies, and social support through integrated audio, video and web-based channels.

### RELATED APPLICATION

This application claims the benefit, under 35 U.S.C. §119(e), of the filing date of provisional application serial No. 60/229,005, filed Aug. 30, 2000.

### FIELD OF THE INVENTION

The field of the invention is health management for persons who have or who are at risk for developing chronic illness

### BACKGROUND

Chronic conditions are the predominant health care problem today, consuming 76% of health care expenses. Individual costs increase dramatically after the age of 65. As the wave of baby boomers reaches and surpasses 65 years of age, the incidence of chronic illness will increase exponentially. Currently, all costs associated with chronic illness approximate $900 billion. By the year 2030, it is estimated that approximately 150 million people in the United States will suffer from one or more chronic illness. This corresponds to a 70% increase in direct medical care costs. With the current health care system designed to primarily service acute health needs, the government and leading foundations are aggressively investigating methods of reducing the personal and economic impact of chronic illness. Among the several approaches examined, regular exercise has consistently been shown to be effective at improving physical and emotional health and quality of life in persons with and without chronic illness.

In the past ten years, several key reports from federal (Healthy People 2000, 1990; U.S. Preventative Services Task Force Report, 1996; Surgeon General's Report on Physical Activity and Health, 1996) and foundation (Successful Aging, the MacArthur Foundation, 1998) sources have been published. These reports demonstrate a consensus within the medical and scientific communities around the evidence that increased physical activity and exercise can improve the physical and emotional fitness, functional status and quality of life of persons with and without chronic illness. In addition, evidence is mounting that shows a positive relationship between increased physical activity (reduction in inactivity), improved health and reduced health care costs in several chronically ill populations.

One of the key questions that remain unanswered is how to translate the existing and future science into effective, accessible, and viable programs that have widespread applicability. Empowering a person to change a health behavior requires education, skill development, structure and emotional and social support. To date, the major efforts to promote increased physical activity have been directed through generalized public health education. Primary and specialty care providers, however, are not commonly trained to counsel patients on exercise, particularly in the areas of improving functional status and reducing disability in persons with chronic illness.

A person with chronic illness or increased risk for illness is without direction and is left to seek out other means of information and guidance surrounding exercise: What kinds? How much? How often? Easily accessible sources of accurate information regarding these questions remain relatively unavailable for the person with chronic illness. What continues to be missing in the continuum of health care is a method or system to integrate all, or even most, of the components of a health management system that is scientifically shown to improve health and prevent the onset, progression or exacerbation of chronic illness. Of the components of health management programs, the least well known, and therefore the least used, is the appropriate use of exercise.

### SUMMARY

A method of coordinating a health management program for an individual is offered, the method comprising: (a) assessing the individual's status; (b) developing an individualized management plan, IMP, for the individual based upon at least the individual's status assessment, the IMP comprising an exercise regimen; (c) monitoring the individual's execution of the exercise regimen; (d) storing the results from steps (b) or (c); (e) measuring changes in any of health, fitness and functional status of the individual; (f) modifying the IMP as a function of data acquired in any one or more of steps (a) and (c)-(e); and (g) repeating one or more of steps (a) and (c)-(f). The method may further comprise (h) reporting at least one of: the IMP, the individual's exercise execution, and the changes in any of the health, fitness and functional status of the individual to at least one of: the individual's health care provider and the individual's insurer. Step (a) may comprise at least one of: (i) the individual completing a self-evaluation; (ii) measuring the individual's performance on a pre-defined set of physical activities; and (iii) a health care provider of the individual's completing an evaluation of the individual. Steps (c), (d) and (e) may occur while the individual executes the exercise regimen. Step (f) may occur while the individual executes the exercise regimen. Step (d) may occur on a server computer. Step (d) may occur on a personal storage device. Step (a) may comprise questioning the individual. Step (a) may comprise physically examining the individual. Step (c) may comprise recording data generated by a fitness machine.

In a further embodiment the fitness machine adjusts its performance based on one of the following: the IMP, the results from step (c), or the results from step (e). In a further embodiment any of a portion of the results from steps (a)-(f) is made available over the Internet. In a further embodiment any of a portion of the results from steps (a)-(f) is made available at an exercise location.

In a still further embodiment, a computer apparatus for use in a health management program is offered, the apparatus programmed to: send and receive exercise result data; send and receive patient status data; send and receive individualized management plan data. In another embodiment the computer apparatus is further programmed to measure changes in a patient's physical status based on the exercise result data and patient status data. In yet another embodiment the computer apparatus is further programmed to alter the individualized management plan data based on the exercise result data and patient status data.

### BRIEF DESCRIPTION OF THE DRAWINGS

FIGS. 1A and 1B are block diagrams of the overall system;

FIG. 2 is a flowchart representing the broad steps of the present invention;

FIG. 3 is a representation of steps involved in generating an individualized health management plan;

FIG. 4 represents the detailed steps in generating the individualized management plans;

FIG. 5 shows the steps involved in implementing the health management plan;

FIG. 6 shows the steps of gathering exercise data; and

FIG. 7 is an overview of the network system.

### DETAILED DESCRIPTION

The present system provides comprehensive, scientifically-based, medically-sound health management programs for persons who have or who are at risk for chronic health conditions, and which quantifies and documents all aspects of the program. The method is an integrated system including scientifically-based algorithms and fitness equipment that: assesses a person's health, fitness and functional status; develops an individualized exercise program targeting specific needs and limitations in health, fitness and function; monitors exercise program progress and adverse events; continuously adjusts exercise program progression in real time; measures changes in health, fitness and functional status; and reports exercise participation and changes in health, fitness and functional status to the participant, his/her health care provider (e.g., physician, physical therapist, psychologist) and health insurance provider. The method is also a vehicle for knowledge delivery of health education information (e.g., nutrition, disease self-management, stress and time management), psychological coping strategies, and social support through integrated audio, video and web-based programming.

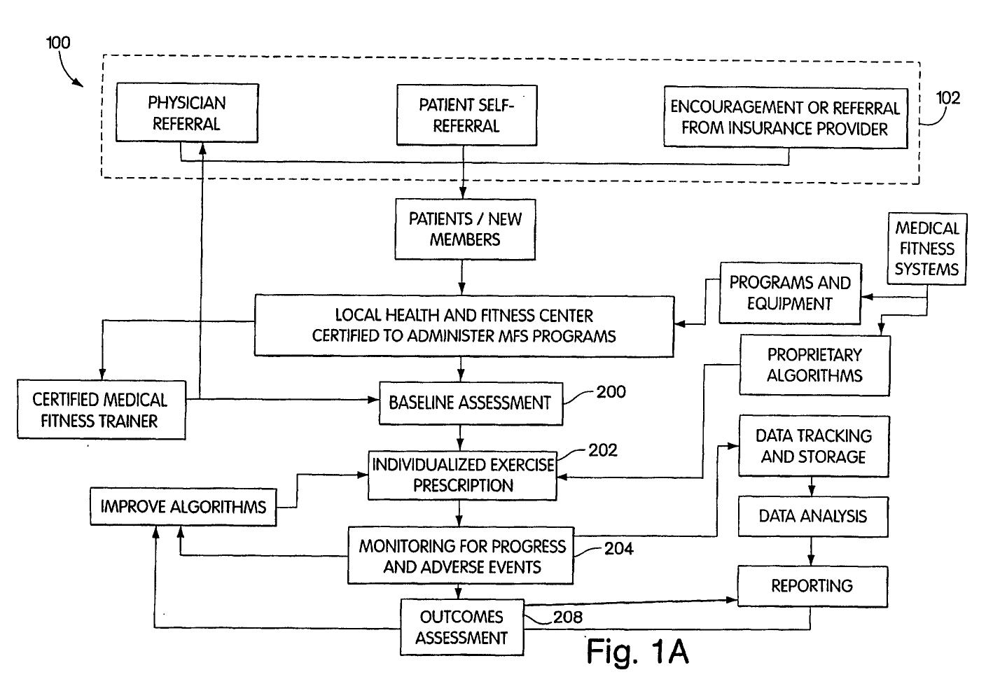

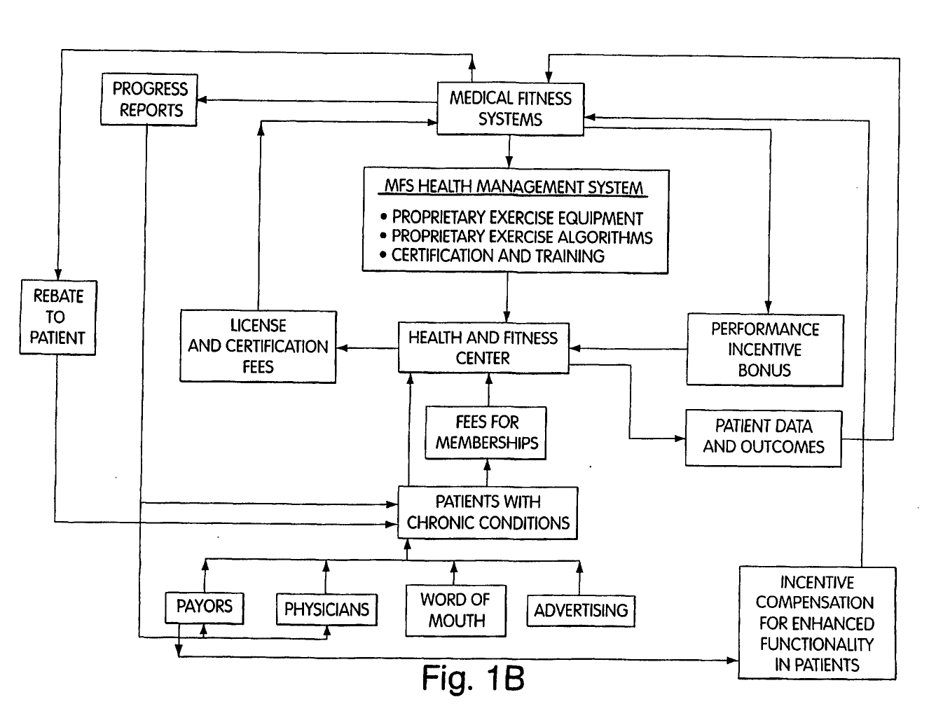

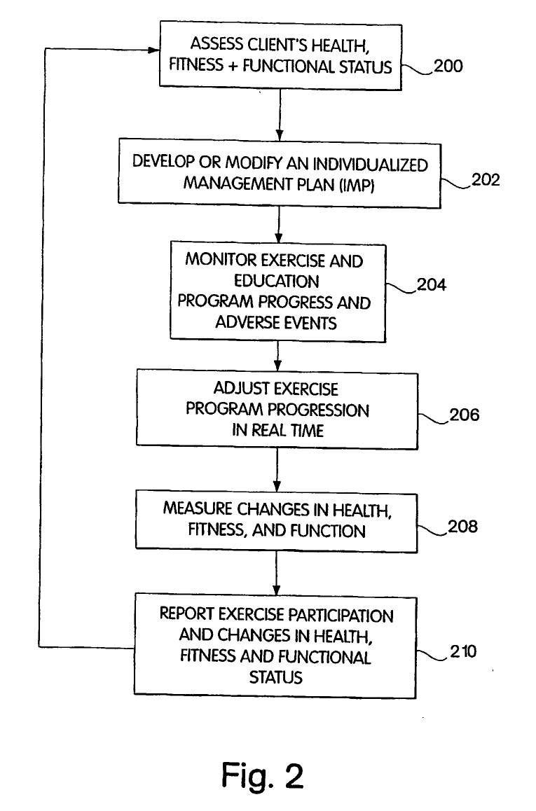

The integrated aspects of each of the following components of a system 100 according to the present invention are seen in FIGS. 1A and 1B. Persons with special health conditions will enter the system 100 by way of step 102, which is by physician referral, self-referral (word of mouth, marketing materials, other forms of advertisement) and by encouragement or direct referral from the insurance provider (payer). As shown in FIGS. 1A and 2, initially at step 200, the health, fitness and functional status of a client (client is preferred although the individual may also be referred to as a patient or participant) is assessed. At step 202, an individualized management plan (IMP) is initially developed, if not already existing or an already existing IMP is modified. Subsequently, step 204, exercise and education program progress is monitored and adverse events are recorded. In view of the monitored exercise program progress and adverse events, at step 206, the exercise program progression is adjusted in real time. Changes in health, fitness and function are measured, step 208, and exercise participation and changes in health fitness and functional status are reported at step 210. The entire process may be repeated over time to adjust the individual management plan to changes in the client's health, fitness and function.

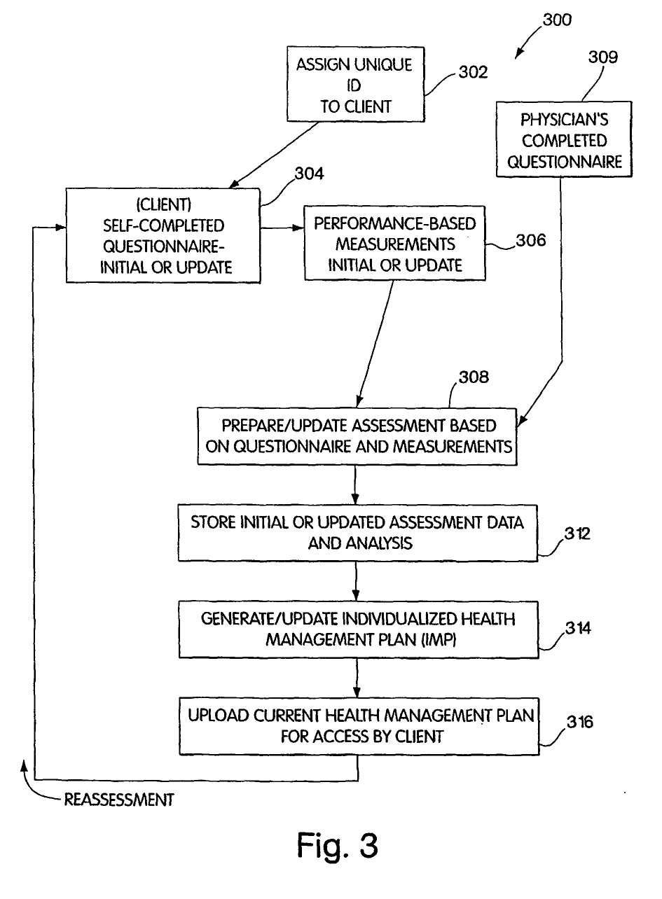

Assessment (step 200) examines the current health, fitness and functional status of the participant. The initial assessment establishes a baseline for use in developing the first exercise prescription and for comparison of future assessments to determine changes in these areas over time. As shown in FIG. 3, the flowchart 300 represents the steps involved in the assessment step 200. Initially, a unique identification number is assigned to each client at step 302. The client completes a questionnaire at step 304. Subsequently, performance-based measurements are taken in step 306. An assessment is prepared at step 308 based on the analysis of questionnaire answers in step 304 and the performance-based measurements at step 306. In addition to the questionnaires completed by the client, each client's physician(s) will be sent a questionnaire to obtain medical clearance, step 309, for participation and to identify any goals or limitations of the participant. The assessment data analysis and physician input are stored at step 312 for subsequent retrieval. The individualized health management plan (IMP) is generated at step 314 based on an assessment at step 308 and input at step 309 and is uploaded for access by the client at step 316. The process may be repeated multiple times by returning to step 304 for subsequent completion of additional questionnaires as well as a repeat of the performance based measurements, step 306.

The assessment is composed of questionnaire- and performance-based measurements. Questionnaires include validated instruments to examine an individual's general health (mental and physical) and functional status, physical activity habits and patterns, medical history, personal characteristics (age, gender, occupation history, marital status), perceived self-efficacy regarding the management of his or her chronic illness and belief in the effect of participation in the health management program. The unique identification number will be used on all data to ensure confidentiality of the information being collected. Questionnaires may be automated and may be completed on computerized forms or directly on a web site. Written informed consent may be collected from each participant at the initial time of contact by a representative of the health management method, to ensure the participant has a clear understanding of the collection, storage and use of all data as part of the method being described in this disclosure.

Performance-based measurements assess muscle strength of the upper and lower extremities, abdomen and back; cardiorespiratory fitness; range of motion of the ankles, knees, hips, spine, shoulders, elbows, wrists, and neck; and a determination of percent body fat. Muscle strength measurement protocols are implemented. A person who has undergone training and has received a certificate confirming the presence of the required skills and competencies needed to adequately perform the assessment regimen will administer the assessment This is represented in FIGS. 1A and 1B as a Certified Medical Fitness Trainer (CMFT). Subsequent assessments will take place at predetermined time points to establish a chronology of changes in measurements over time. These time points will correspond to the start and completion of preset programs or dates that are established as part of goal setting. All assessment data will be stored in a secure location to ensure confidentiality, access for program development, data monitoring, and reporting.

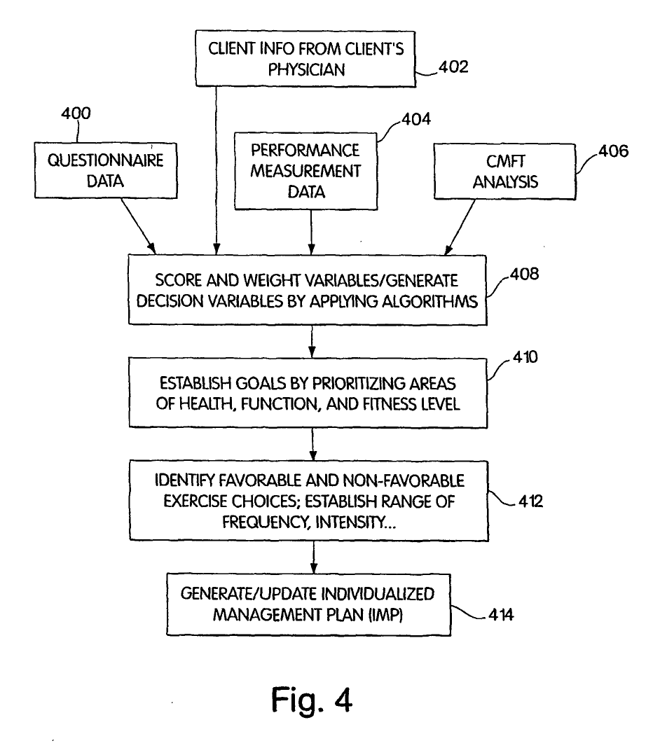

An individualized health management plan is developed from the data generated in the assessment as shown in FIG. 4. All of the data, i.e., questionnaire data 400, client's physician data 402, performance measurement data 404, CMFT analysis data 406, are run through one or more algorithms that score and weight variables and create a list of “decision variables.” These decision variables are subsequently operated on by additional algorithms that establish program goals, step 410, by prioritizing areas of health and functional status and fitness level and factoring in input from the person's physician and other data collected during the assessment. The algorithms and decision variables for a particular patient are dependant upon the data collected above as well as multiple variables including, but not limited to, age, height, weight, illness (if any), symptoms, etc.

These algorithms are formulas or systems that use specific variables, for example, but not limited to, age, pain severity level, fatigue, exercise history, medical history and the like, which can be generated through the assessment phase, to determine appropriate components of the management plan thus enabling the development of an individualized program that targets priority needs. These algorithms may be based on both qualitative and quantitative data as to which combinations or sub-combinations of exercises, settings, frequency of occurrence, etc., produce positive results for individuals suffering from particular chronic conditions. Merely as an example, it may be known that a certain course of exercise is beneficial to sufferers of fibromyalgia. This baseline course of exercise could be modified for an individual depending on the individual's specific parameters as found at the initial assessment. Thus, the course of exercise for this person may be personalized based on his or her current measurements.

Further decisions are calculated, step 412, through other algorithms to determine a list of favorable and non-favorable exercise choices; establish a range of frequency, intensity and duration for the exercise prescription; establish an exercise progression pattern; create a list of health education modules to be delivered during participation in the exercise sessions; and establish the time point for re-assessment. The health management plan, including the exercise prescription and education module schedule, is generated and uploaded, step 414, to a site where the participant can load the entire plan onto a hand held or portable device such as a smart card or personal information assistant or manager, e.g., a Palm Pilot. In addition, a workbook/handbook of education materials (e.g., disease background, prognosis, medications, treatment pathway, and self-management information) is provided.

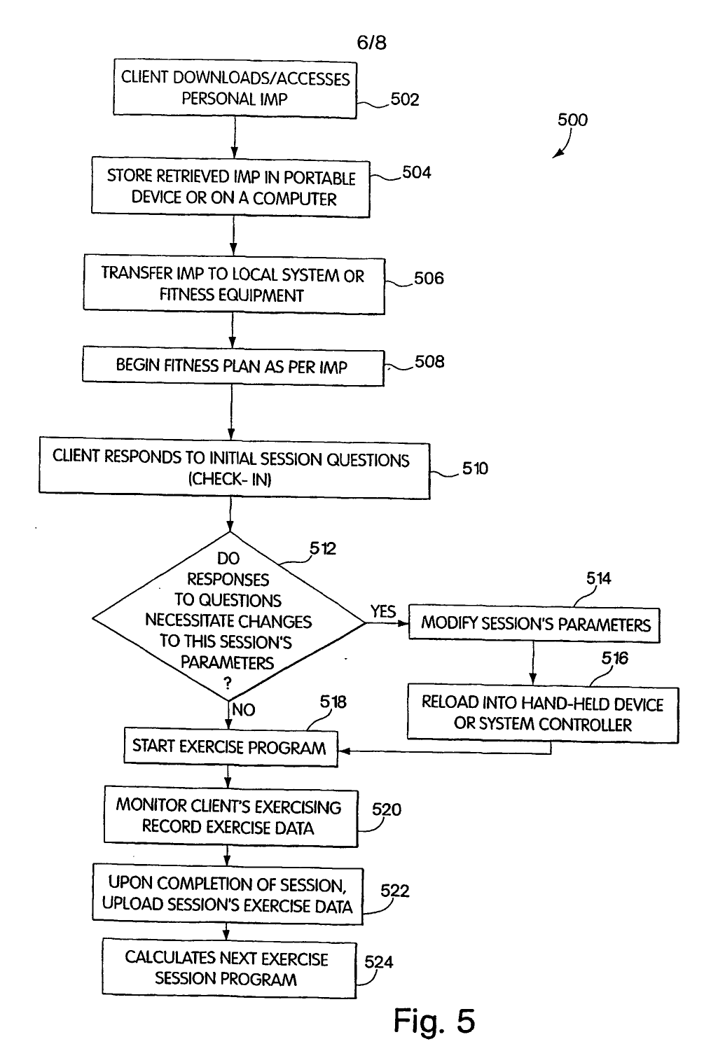

After the IMP is generated and uploaded, the client is then ready to start exercising according to the plan. With respect to the flowchart 500 as shown in FIG. 5, a client would then download and/or access his or her personal IMP at step 502. The retrieved IMP is stored in a portable device or a personal computer at step 504. As will be discussed below, the IMP can be transferred to a local system network at an implementation site or a particular piece of fitness equipment, step 506, by the interaction of the portable device with the fitness equipment or the interaction of the fitness equipment with the computer. As per the IMP, the fitness plan is started at step 508. Initially, however, the client responds to questions at session check-in, step 510. If, as determined at step 512, the responses to the check-in questions necessitate changes to the session parameters then, at step 514, the session's parameters are modified and the modified IMP is reloaded into the hand-held device or system controller at step 516. Control then passes to step 518 if either the responses to the questions at step 512 do not necessitate changes or a new/modified IMP has been loaded and the exercise program has started. Once started, step 520, the client's exercising is monitored and the exercise data is recorded. Upon completion of the session, step 522, the session's exercise data is uploaded for later analysis, retrieval and use in determining the next exercise session program, step 524.

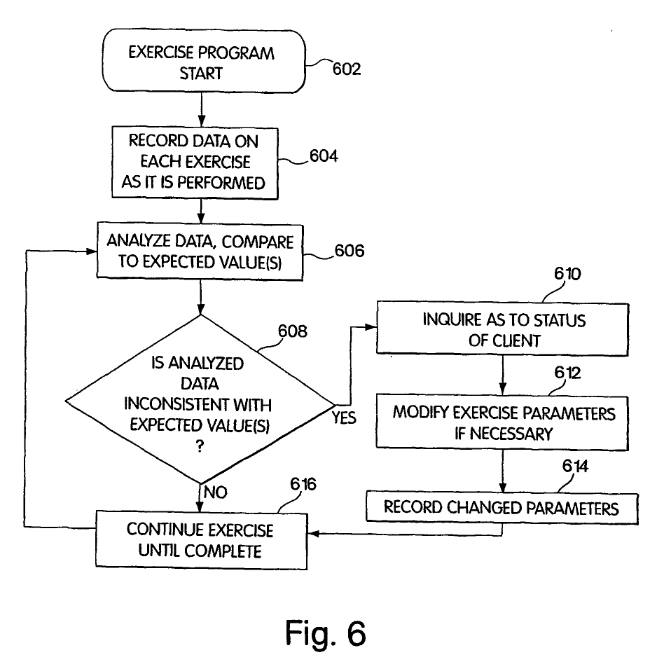

The monitoring of the client's exercising (step 520) is described in further detail with respect to FIG. 6. At step 602, the exercise program is started and data on each exercise as it is performed is recorded at step 604. This data includes, but is not limited to, heart rate, blood pressure, temperature, blood oxygen saturation, and the like and exercise performance variables, including but not limited to, equipment settings (e.g., time, treadmill speed, resistance level) and technique (e.g., range of motion and speed of movement of resistance equipment). The data is analyzed and compared to expected values at step 606. At step 608, an evaluation of the analyzed data is performed and compared to expected values. If the analyzed data is inconsistent, the status of the client is determined at step 610. If necessary, at step 612, the exercise parameters are modified and the changed parameters are recorded as part of the IMP stored on the hand-held device and networked system at step 614. Control passes to step 616 where the exercise is continued until complete with subsequent analysis of data being performed again at step 606.

It should be noted that the modification of the exercise parameters at step 612 is different than that at step 514 although the same result is desired. At step 512 it is the client's own self-analysis that may or may not lead to modification of the session's parameters. Thus, if the client reports that he or she is not feeling well or is sore in a particular area, the system will then modify the parameters. In addition, as described with reference to steps 608-614, if the client makes no indication of impaired condition but the measured exercise data indicates otherwise, the system will detect this and modify the parameters. Thus, even if the client is unaware or has declined to mention “not feeling well,” the system can detect this by the analysis of the actual exercise data.

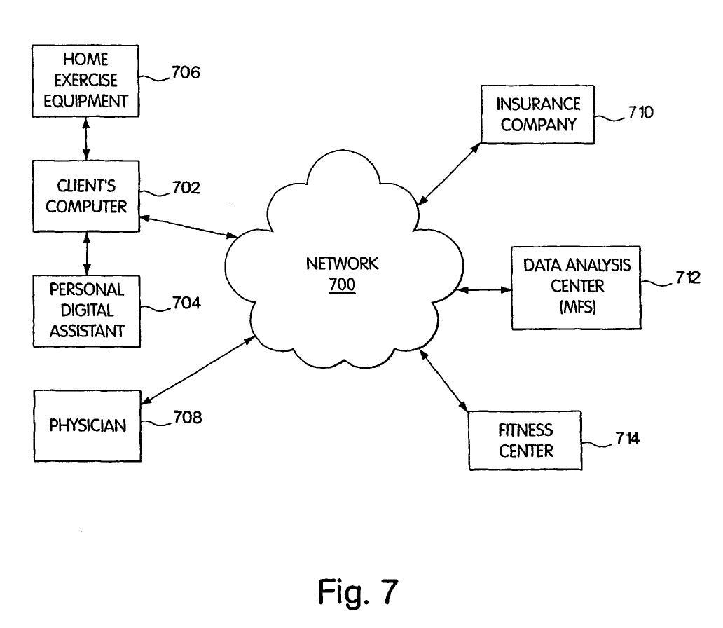

As shown in FIG. 7, all of the major components of the system are connected via a network 700, for example, the Internet, for the sharing and transferring of data. Thus, a client's computer 702, connected to a personal digital assistant 704 and home exercise equipment 706, communicates with a data analysis center 712 in which the algorithms, educational materials, certification materials and the like are all centrally accessed. Further, a physician 708, insurance company 710 and fitness center 714 are each connected to the network 700 to facilitate the exchange of data with respect to a particular client. Of course, the exchange of data would be encrypted and/or password protected in order to protect any confidential medical information of the client. Any one of a number of known encryption or password-protection schemes could be implemented.

Program implementation occurs at home, a community-based fitness or wellness center, or any other site that installs the described technology. In the home, the health management program can be uploaded to the piece of fitness equipment or the computer located in the home via an Internet connection. The home program provides a list of detailed instructions for the number of minutes of cardiovascular exercise at a certain heart rate, which strength training exercises and the number of sets and repetitions, flexibility exercises, and a list of health education materials that the person can access through the internet or via recorded media. A computer board built into the piece of home equipment will interface directly with a computer that is responsible for communicating with the home equipment. Without a piece of fitness equipment that contains the proprietary technology, specially designed software running on a computer may act as the personal information storage device and interface with the central system computer.

Specially trained on-site staff (Site Manager, Site Director, Certified Medical Fitness Trainer) facilitate the fitness center-based implementation. The trainer will introduce the participant to the exercise program through one-on-one instruction sessions until the participant is capable of exercising independently or chooses to join a group of persons also using the health management method. At the beginning of each exercise session the participant checks in by interfacing his/her personal information storage device (smart card or personal information manager) with a dedicated computer at the exercise facility. This computer may store a copy of the information on each participant's personal storage device. As described above, the initial interface produces a greeting and interaction with the participant asking questions relating to his/her current state of health and well being. This information will be used as a check to finalize the exercise program for that session. If normal, the exercise program scheduled for that session is implemented. If, however, the person is not feeling well, answers to the questions will trigger an algorithm that will modify the exercise program for that day to ensure safe participation and reduce the chance of injury.

After completing the electronic check-in, the participant follows the exercise program, which details the order of exercises. Measurement technology may record the data on exercises performed at each session including the time, speed, distance, and incline of a treadmill; the time, speed, average number of revolutions per minute, distance, and seat adjustment on an upright or recumbent stationary bicycle; the time, speed, average number of steps per minute, and distance covered on an elliptical device, stair climber or other cardiovascular exercise equipment, such as a rowing machine or cross-country skiing simulator. An amount of resistance (weight), range of motion, speed of movement, seat and other body size adjustment on resistance training equipment is also captured.

This exercise equipment technology is provided in two forms: a retrofit system that attaches to different models of currently manufactured fitness equipment and an all-in-one piece of equipment that already incorporates the advantages of the present invention. All-in-one equipment/interfacing technology will be isokinetic, where the machine controls the speed of angular velocity, while a dynamometer or actuator provides accommodating resistance to joint movement. This form of resistance is ideal for special populations due to the accommodating nature where the machine provides an “equal and opposite” resistance to joint movement. The isokinetic form of resistance allows a person to stop anywhere throughout the range of motion and have little or no resistance on the joint-unlike today's common types of resistance equipment, which is isotonic, i.e., plate-loaded.

In addition to exercise performance, this recording device will provide feedback to the participant regarding proper exercise technique (speed of movement and range of motion). This feedback capability will have individual parameters to adjust according to the specific musculoskeletal limitations of each participant. Also, the device will query the participant if the exercise is not performed correctly (too slow or not through the full range of motion) to see if there is a problem (pain, soreness, fatigue, or other) and then will use an algorithm to decide whether to reduce the resistance, speed, or range of motion for that day, to eliminate the exercise from that session or to stop the entire exercise session and seek assistance from the professional in charge of the facility and/or recommend checking with his/her physician. One or more fitness professionals will monitor every participant of this program in his/her respective facility. The name of the fitness professional would be included in the participant's plan. Positive reinforcement is a critical component of successfully adopting a positive health behavior. Therefore, after completing every exercise, one of several statements is presented on the LCD panel of the participant-technology interface encouraging pride and a sense of accomplishment in the participant for completion of the activity.

Reporting of participant data is a part of the program as well. Participants have access to their own data at any time via a website. The use of security codes is used to ensure confidentiality and to limit access to only the authorized individual. Data can be presented in various forms (written, graphical) and can be printed or sent as email with an appropriate level of security. Participants will receive periodic reviews, (e.g., monthly reviews of their progress that will be delivered via email or accessed via their security code.) These reports provide another forum to reinforce positive behaviors in participants. In addition, the open communication enables feedback about the system to refine this technology and the method of health management.

In addition to participant reports, a summary of a participant's baseline assessment and exercise program and subsequent reports of re-assessments, new programs and quantification of changes in outcome variables, will be sent to one or more health care providers of the participant's choice. The health care provider report has a unique design and content structure and contains graphical and written representation as well as the raw data on compliance, exercise performance, assessment outcomes, education modules completed and behavioral milestones achieved by the participant. Reports are also delivered into a patient's electronic medical record, where possible, to encourage physician reinforcement and support of the participant's efforts and positive health behaviors. Another report, also uniquely designed, is sent to the participant's health insurance provider to document compliance and progress throughout the health management program and to qualify for reimbursement of health insurance premium fees.

Education is an important component in the successful adoption of a positive health behavior. Health education modules are delivered through the LCD panel on the participant-technology interface. This occurs while on a piece of cardiovascular equipment and during the timed rest period between multiple sets of a resistance exercise, as well as facility wide conferences and education sessions. Education is presented in several forms. While working on a piece of cardiovascular equipment, the user could choose to access a web site and select a lecture on one of several topics of interest (general health, exercise, nutrition, stress management, etc.).

On resistance equipment where one sits for far shorter periods of time, education is presented in shorter “knowledge bites.” This presentation takes several forms, including quizzes (multiple choice, true-false, question alone) and statements/questions. Regardless of format, answers are provided in the form of a “knowledge bite” to facilitate learning and awareness of relevant information. Information will be aimed to encourage decision making, (e.g., getting a flu shot) and will provide updates regarding current findings in medical research (e.g., appropriate use of nutritional supplements, new medications, or data supporting the participation in a program of regular exercise).

Education modules are developed in several categories (e.g., general health and well being, specific disease or illness, age appropriate) and are selected for each individual based on information provided at the initial assessment and subsequent follow up assessments. In addition, the participant has the choice to manually select any education module in the library in addition to those programmed as part of the person's individualized health management program. The system also offers restricted membership chat rooms for facilitating the adoption of positive health behaviors in participants of the health management program. The chat rooms can be accessed at any time, including while exercising. Additional education opportunities are delivered through web-based newsletters, articles summarizing research findings, copies of articles, ties to other sources of information, (e.g., National Institutes of Health, Arthritis Foundation, American Diabetes Association), and courses in related topics (e.g., exercise, nutrition, illness specific self-management, stress management) that increase the knowledge level of participants, and therefore the ability of people to make health related decisions that positively affect health and quality of life.

To facilitate compliance and success of participants, an incentive program is part of the system described in this disclosure. Participants will accumulate “healthpoints” for every activity they complete—exercise compliance, web-based education, video and audiotape education—and for maintaining a healthy lifestyle. These points will be accumulated and exchanged for gifts and prizes that cost certain numbers of points.

Education of the health care provider is important to maximizing the use, and therefore the impact, of the described health management method. Physicians and other health care providers who do not have formal training in the areas of exercise, nutrition and lifestyle management, will have web-based access to articles, updates, previously recorded presentations, discussion sites and scientific references regarding the contribution of health self-management and specifically the components of the method described in this disclosure. The goal of the provider education services and products is to provide the health care community with the most current, accurate scientific data and relevant information that will help them to make good decisions for their patients and, where appropriate, integrate this health management method into the care they provide.

Education of the fitness professional to attain CMFT status takes several forms and is important to the success of participants and the implementation of this health management method. Training will include web-based courses, lectures, on-site training and several levels of programming, including a multi-day course involving lectures and hands-on experiences with problem solving, equipment and technology. Courses will teach the pathophysiology, normative values for physical and emotional characteristics and limitations, contraindications of exercise, and exercise prescription development for many health conditions. Those who successfully complete these courses will have knowledge, technical skills, and competencies in exercise physiology, motivation, compliance, group dynamics and facilitation, as well as general communication and listening skills, and cultural competence. Programs will be offered for basic, intermediate and advanced levels, and will provide continuing education opportunities to maintain certificate standing. Fitness professionals have access to several “lines of learning” and knowledge maintenance through didactic and interactive programs, web-based information and courses and chat rooms.

The current system incorporates a unique line of resistance training equipment for older adults and persons with chronic disease. A drawback of current resistance equipment is that the devices are sized to accommodate persons with normal ranges of joint motion, including those of the hands. In addition, current resistance equipment uses pulleys and stack weight to supply a constant (isotonic) resistance to joint movement, which limits the level of resistance to the ends (weakest positions) of the muscle length-tension curve.

This equipment of the present invention is designed specifically to meet the unique biomechanical, structural, and mobility limitations of the person with chronic illness, particularly musculoskeletal system involvement. This line of equipment has special adjustments to enable persons with limited ranges of motion of hips, knees, shoulders, elbows and hands to perform appropriate exercises comfortably and safely. In addition to the difference in design shape and adjustments, this equipment supplies resistance via an isokinetic dynamometer or actuator that controls the speed of movement, not the resistance. This difference in the form of resistance enables a person with chronic illness to perform muscle-strengthening exercises throughout any range of motion while maximizing the total length-tension curve of a muscle by providing varying resistance throughout the joint range of motion corresponding to the strength of muscles at various points in the joint range. Furthermore, isokinetic technology allows the exerciser to stop at any time throughout the range of motion and have the resistance disappear due to there being equal and opposite resistance to the amount of muscular effort.

Technology enables the participant to begin an exercise session at any time and to perform the exercise at any site that incorporates the health management technology. This allows those who travel for short or extended periods of time or relocate to maintain the positive healthy habits established through this health management method and, advantageously, to continue to benefit from their individualized exercise program regardless of geographical location. The data from all exercise sessions are stored at a central location and participants can access their exercise data via the Internet regardless of where they are and are portable (can be taken with them) via the smart card and handheld personal data system (Palm Pilot).

A large amount of data is one of the key consequences of this method of health management. This invaluable asset will be mined to continuously evaluate, refine and evolve the health management method described here.

An embodiment of the method includes an integrated system of technology, scientifically-based algorithms and fitness equipment that: assesses a person's health, fitness and functional status; develops an individualized exercise program to address specific needs and improves limitations in health, fitness and function; monitors exercise program progress and adverse events; continuously adjusts exercise program progression in real time; measures changes in health, fitness and functional status; and reports exercise participation and changes in health, fitness and functional status to the participant, his/her health care provider (e.g., physician, physical therapist, psychologist) and health insurance provider. The method is also a vehicle for knowledge delivery of health education (e.g., nutrition, disease self-management, stress and time management), psychological coping strategies, and social support through integrated audio, video and web-based channels.

Other embodiments of the method and system enable the adoption and long term maintenance of an exercise and education program that is designed to address the specific needs and improve the limitations of individuals with and without chronic illnesses.

Having now described a few embodiments of the present invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. Merely as an example, the connection to the Internet could be via a wireless connection without the necessity of a hard-wired connection such as a phone line and modem or cable network and cable modem. The personal device used to access the IMP could also be a web-enabled wireless telephone or similar device. Of course, fitness equipment either retrofitted to operate with the present invention or having components originally installed may be part of a wireless LAN within a facility, thus minimizing any retrofit requirements of the infrastructure of the fitness center.

What is claimed is:

1. A method of coordinating a health management program for an individual, the method comprising:
(a) assessing the individual's status;
(b) developing an individualized management plan, IMP, for the individual based upon at least the individual's status assessment, the IMP comprising an exercise regimen;
(c) monitoring the individual's execution of the exercise regimen;
(d) storing the results from steps (b) or (c);
(e) measuring changes in any of health, fitness and functional status of the individual;
(t) modifying the IMP as a function of data acquired in any one or more of steps (a) and (c)-(e); and
(g) repeating one or more of steps (a) and (c)-(f).

2. The method of claim 1, further comprising:
(h) reporting at least one of: the IMP, the individual's exercise execution, and the changes in any of the health, fitness and functional status of the individual to at least one of: the individual's health care provider and the individual's insurer.

3. The method of claim 1, wherein step (a) comprises at least one of:
(i) the individual completing a self-evaluation;
(ii) measuring the individual's performance on a pre-defined set of physical activities; and
(iii) a health care provider of the individual's completing an evaluation of the individual.

4. The method of claim 1, wherein steps (c), (d) and (e) occur while the individual executes the exercise regimen.

5. The method of claim 4, wherein step (f) occurs while the individual executes the exercise regimen.

6. The method of claim 1, wherein step (d) occurs on a server computer.

7. The method of claim 1, wherein step (d) occurs on a personal storage device.

8. The method of claim 1, wherein step (a) comprises questioning the individual.

9. The method of claim 1, wherein step (a) comprises physically examining the individual.

10. The method of claim 1, wherein step (c) comprises recording data generated by a fitness machine.

11. The method of claim 10, wherein the fitness machine adjusts its performance based on one of the following: the IMP, the results from step (c), or the results from step (e).

12. The method of claim 1, wherein any of a portion of the results from steps (a)-(f) is made available over the Internet.

13. The method of claim 1, wherein any of a portion of the results from steps (a)-(f) is made available at an exercise location.

14. A computer apparatus for use in a health management program, the apparatus programmed to:
send and receive exercise result data;
send and receive patient status data;
send and receive individualized management plan data.

15. The computer apparatus of claim 14 further programmed to measure changes in a patient's physical status based on the exercise result data and patient status data.

16. The computer apparatus of claim 14 further programmed to alter the individualized management plan data based on the exercise result data and patient status data.
